(19) United States
(12) Patent Application Publication
(10) Pub. No.: US 2008/0271608 A1
(43) Pub. Date: Nov. 6, 2008

(54) Brewing Beverage Dispenser Comprising an Improved Boiler and a Method for the Production Thereof

(75) Inventor: Gilles Morin, Saint Honorine du Fay (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 11/720,368

(22) PCT Filed: Nov. 28, 2005
(86) PCT No.: PCT/FR05/02952

§ 371 Date: May 29, 2007

(30) Foreign Application Priority Data
Nov. 29, 2004 (FR) 0412634

(51) Int. Cl. A47J 31/54

(52) U.S. Cl. 99/294; 99/302 R

(57) ABSTRACT

The invention relates to a brewing beverage dispenser provided with a housing comprising means for pumping water from a container, transferring said water through a boiler (6) to an brewing chamber (3) containing brewable product and for removing said brewed product from the brewing chamber. Said boiler (6) comprises a cylindrical body (20) containing an electric heating element (21) and a water conduit (23), wherein said heating element and water conduit (23) form two helixes having different diameters and rotatable about the longitudinal axis (V) of the boiler body substantially through the entire height thereof. According to said invention, said boiler body (20) comprises a steam conduct (25) which forms a helix mounted along the longitudinal axis (V) of the boiler (6) substantially through the entire height thereof.

The present invention relates to an appliance of the distributor type for beverages brewed starting from ground or powdered food products for brewing or percolation, such as ground coffee, tea, chocolate, etc.

An appliance for preparation and distribution of hot beverages generally comprises a cold water tank, an electric pump, a unit forming a boiler and a brewing head adapted to receive the product in powder or ground form in order to inject therein hot water coming from said boiler, the beverage obtained being then directed towards a collecting container. At the end of the brewing cycle, the brewing head must be opened in order to be able to again introduce new brewing product after having evacuated the remainder of brewed product. These appliances are sometimes caused to provide steam necessary to make a cappuccino or tea. To do this, they must have a temperature control for the heating element suitable to produce steam and a distribution valve placed at the exit of the boiler. Such a solution poses problems of scaling of the valve and thus of a limited useful life of the machine.

To overcome this disadvantage, a solution has been proposed in the document EP 0 342 516 where the boiler presents two separate conduits for the production of hot water and steam while being heated by a common heating element according to specific temperature settings. The two steam and hot water conduits are machined on the level of the plane of separation of upper and lower discs forming the boiler, one being disposed at the periphery and the other in the central zone of this plane, the heating element, itself, being placed on the external face of the lower disc. Placing of the two discs of the boiler in contact acts to close the conduits. This solution makes it possible, certainly, to place the distribution valve at the entry of the boiler thus avoiding its scaling, but finds its limits when the steam conduit and the hot water conduit are practically at the same distance from the heating element. This presents the disadvantage of having to heat the boiler substantially to produce steam and of then having to wait a certain time before being able to make coffee, the boiler having gone up too much in temperature. In addition, being a boiler with plane heating conduits, it is present in the form of a disc of very large diameter compared to its width and thus of substantial horizontal size, poorly compatible with a beverage distributor requiring generally a rather slender and vertical design.

Another solution has been described in the document FR 2 802 073 where the boiler is vertically cylindrical and contains a water circulation channel in the form of a helical tubular conduit whose path follows that of an integrated heating resistance, with the water conduit, in the boiler body. This document describes, certainly, a slender and vertical boiler to produce hot water, but which does not comprise a steam conduit and so it also has the disadvantages of the state of the art exposed above.

The document EP 0 353 425 describes an instantaneous water heater for a coffee machine having an inclined water conduit to allow the descent by gravity of the brewing water towards the brewing chamber. This water conduit is in the shape of a spiral and is arranged around a heating element and an adjacent concentric steam conduit, those being also in the shape of a spiral. One notices however that these conduits are each formed of only one open loop and that they are integrated in a water heater in the shape of a flat disc, the conduits being very slightly inclined, extending mainly in a plane. Such a water heater is not adapted for use in a coffee machine with a pump that must generally provide a substantial flow of hot brewing water.

The document DE 1 265 892 describes an electric water heater intended to produce only hot water having a cylindrical tubular body whose walls contain peripheral heating elements in a spiral and a helical water conduit disposed towards the interior. This water heater is by no means envisaged to be used with a brewed beverage distributor and does not comprise any conduit or means for production of steam.

In addition, document WO 99/12456 also describes a cylindrical boiler with a vertical longitudinal axis made of a heat conducting material whose body is crossed by channels for passage and heating of water coming from a cold water tank and opening into a brewing chamber supported at the upper part of the boiler. The channels are parallel to the longitudinal axis of the boiler and are located to one side and the other of a central bore. These water channels are intentionally formed without an elbow for reasons of easy descaling, the boiler body being of extruded aluminum and the water channels lined with stainless steel. The heating resistance is U-shaped, it is placed next to the heating block and extends parallel to the longitudinal axis of the boiler. In addition, this appliance also fulfills a steam function, in particular by placing a secondary boiler alongside the body of the first by arranging a flattened chamber. For this, the secondary boiler presents a shaped case adapted to mate with the side wall of the first boiler at the side of the heating resistance. Such a construction ensures, certainly, two functions: hot water and steam with the same heating resistance, while ensuring a good maintenance in temperature of the brewing chamber. However, the heat exchange performance between the heating element and the water conduits is rather poor in the first boiler. In addition, in the second boiler for production of steam, the steam coming in direct contact with the aluminum parts of the boiler, there could be problems of toxicity.

The goal of the present invention is to overcome the above mentioned disadvantages and to provide a brewed beverage distributor having a boiler adapted to carry out an improved thermal transfer from a heating element towards the hot water and steam conduits, while being adapted to avoid possible problems of toxicity or scaling in contact with the water or steam with certain materials of the boiler.

Another goal of the invention is a brewed beverage distributor having an improved boiler adapted to realize, with only one heating element, a brewing with water passing in the hot water conduit immediately after the passage of steam in the steam conduit.

Another goal of the invention is a distributor of brewed beverages having an improved boiler, of simplified construction and which can be industrialized in an economical way for mass production, while being reliable in operation.

These goals are achieved with a brewed beverage distributor having a case containing means for pumping water from a tank to send it through a boiler into a brewing chamber containing a product to be brewed, then to evacuate it in brewed form out of the chamber, said boiler comprising a cylindrical body integrating an electric heating element and a water conduit, the heating element and said water conduit forming two helices of different diameters coiled around the longitudinal axis of the boiler body, substantially over its entire height, by the fact that said boiler body integrates a steam conduit forming a helix arranged along the longitudinal axis of the boiler, substantially over its entire height.

Such a distributor of brewed beverages can be a coffee machine than can make coffee of the espresso type by delivery of hot water under pressure, via a water conduit, through the coffee grounds contained in the chamber, then by evacuating brewed beverage obtained outside the appliance, where it is collected in a cup. Such an appliance has moreover means to produce steam, while causing water to pass via a steam conduit, and which is then used to make a cappuccino, or tea or to heat a liquid.

By water conduit one understands a conduit adapted to provide hot brewing water to infuse the product which is inside the brewing chamber when the water conveyed by the pumping means passes through this conduit inside the boiler. By steam conduit one understands a conduit independent of the first, but connected to the same hydraulic system upstream, conduit which is adapted to receive cold water at the entry to produce either steam, or hot water, collected then outside the appliance, after passage of the water through this conduit to the interior of the boiler, but while bypassing the brewing chamber.

According to the invention, the means for producing steam are fabricated in the form of a steam conduit that is helical, or forms a helix, belonging to the boiler body while being arranged along the longitudinal axis of the latter, over its entire height. By conduit forming a helix one understands a conduit having at least two loops, or turns, each loop ending at a different height compared to its starting point. Thus, the same boiler body contains at the same time the heating element and two other independent water conduits, called herein water and steam conduits where, for more compactness, the two conduits are heated by the same heating element. The boiler body then contains a structure in triple helix extending along its longitudinal axis, substantially over its entire height, which already makes it possible to obtain a cylindrical configuration of elongated form for the boiler. Preferably, the helices are made with a constant pitch over their height, to obtain more uniformity in the distribution of heat in the volume of the boiler.

The three helices are at a short distance from one another and are preferably connected together, at least by conducting bridges of material that is a good heat conductor, while being spread out in height. A helical heating element extending over the entire height of the boiler ensures already a good temperature distribution inside the boiler body. Thus, such a structure in triple helix presents properties of good thermal transfer between the heating element and the steam and water conduits, each one of these conduits being disposed at a predetermined constant distance with respect to the heating element throughout the entire volume of the boiler, the helices being coiled around one another. In addition, a steam extraction provides at one time more heat to the boiler, heat that is by this fact better distributed in the volume of the latter, without creating zones of hot points. Such a construction ensures at the same time a good output from the boiler, a fast temperature setting and a temperature for extraction of beverage or production of steam that is optimized and constant over time during operation of the machine, without taking account of its initial operating state.

Advantageously, the winding diameter of the steam conduit and the pitch of its helix are appreciably equal to those of the helix of the heating element.

A steam conduit thus produced is parallel at every point of its path to the heating element and follows the turns of the latter well, for an optimized thermal transfer. In addition, the water conduit having a diameter different from that of the heating element, it is sufficiently spaced from the heating element so that it can make coffee immediately after having sent steam through the steam conduit, but while being heated in a homogeneous manner within the boiler.

Preferably, the external wall of the steam conduit is adjacent to that of the electric heating element.

By external wall of the steam conduit adjacent to that of the heating element, one understands that the two walls can be in contact or be disposed at a very short distance, about a few millimeters from one another. Thus, so that the steam conduit can absorb all the calories provided by the heating element, it must be in thermal contact with this latter. This thermal contact can be effected directly or with the help of a solder bead or a molded material. During tests carried out in the laboratory, a distance of 2 mm is preferable in order to ensure at the same time a good thermal contact and to make it possible for a material that is a good conductor of heat to be inserted between the two walls and to connect them.

According to an advantageous embodiment of the invention, said water conduit and steam conduit are metal tubes that are overmolded together with the heating element, to form the boiler body.

This solution makes it possible to realize, in an economic way, two independent helicoidal conduits, spread out in height, of materials different from that of the boiler body, while making them fixed together and with the heating element, at every point of the volume of the boiler body, by a filler material having good thermal conduction properties. Thus, the steam or water conduits can be made out of a material inert to water, for example stainless steel, in order to avoid problems of toxicity due to contact with the boiler body, while using for the latter a material easily formed by molding, for example an aluminum alloy.

Usefully, said water and steam conduits are composed of end pipes that are straight and said heating element is composed of terminations that are straight, the end pipes and terminations being oriented along the tangent to the external diameter of their respective helix.

These end parts are the terminal parts of the helices of the two conduits and the heating element, which extend outside the mold. For technological constraints of molding, these parts must be straight. In order to avoid pressure losses inside these conduits and to thus obtain a good flow of fluids through the conduits, and also to facilitate coiling of the heating element, it is preferred to make the straight end parts of said conduits and of the heating element in the prolongation of the final turn of the helix, along a tangent to the latter.

Advantageously, at least one part of said end pipes of said conduits and/or at least one of said terminations are parallel to a first median plane of the boiler body which is perpendicular to a second median plane of the boiler body which is, itself, parallel to the other end pipes and/or to the other termination or terminations.

Indeed, the overmolding of a structure in triple helix, each helix comprising two end parts for connection to the hydraulic or electric circuits of the appliance, poses many problems for fabrication of the mold and its mating plane for the spatial orientation of all the terminations. Ideally, the terminations should be parallel to one another and oriented along a median plane of the boiler body. However, because of their arrangement inside the appliance and in order to optimize the space that they occupy, considering that they must be connected to different circuits, it is preferred to arrange them in an angularly offset manner. Thus, after tests and study, such a solution with transversal terminations and pipes makes it possible to use certain terminations or ends to achieve positioning inside the mold and to close the mold on those remaining. As an example, the terminations of the heating element are transverse to the end pipes of the steam and water conduits.

Preferably, one of the end pipes of said water conduit is prolonged by an elbow that emerges at the bottom of a brewing chamber oriented along the longitudinal axis of said boiler and with which it forms a single part.

Thus, the brewing chamber is in contact with the boiler, the outlet end pipe of the water conduit emerging directly at the bottom of the chamber before leaving the boiler, for an optimized thermal transfer, without heat losses, between the two parts.

Advantageously, said brewing chamber is overmolded with said boiler body.

One thus obtains a compact boiler and brewing chamber assembly providing a good temperature homogeneity inside the chamber. In addition, this assembly can be produced in an economical manner by only one molding operation.

Preferably, the ratio between the external diameter of the body of the brewing chamber and that of the body of said boiler is comprised between 0.6 and 0.8.

The brewing chamber must have a diameter making it possible to obtain ground coffee “pucks” that are larger in diameter than in height, for a sufficient pressure loss of the brewing water through the grounds while making the coffee. The brewing chamber is generally lined by a cylindrical stainless steel tank having a thickness ranging between 1.2 and 1.3 mm. The external part of aluminum molded around the tank must then have a minimal thickness, but estimated in a manner that it can resist the pressure of injection during overmolding and limit the losses of heat in the zone of the brewing chamber, this thickness being of the order of 2 to 3 mm. The outer diameter of a brewing chamber thus obtained then is comprised between 40 and 50 mm. In addition, the boiler body must have a minimum diameter in order to be able to contain all its components and to ensure a good thermal transfer inside its volume. After having manufactured and tested several prototypes, it has been shown that these criteria were well filled for a ratio of the external diameters of the chamber and the boiler body comprised between 0.6 and 0.8.

In an advantageous manner, said brewing chamber comprises a filter plate and receives a pressing piston displaceable along the longitudinal axis of the boiler while being actuated by a drive means and presenting a conduit for passage of the brewed product towards an outlet opening under the effect of said pumping means when the piston closes the brewing chamber, said filter plate being mounted movably in said brewing chamber by means of an ejection mechanism comprising a shank slidably mounted in a bore formed in the body of said boiler along its longitudinal axis.

Thus, the brewing chamber receives the brewing product, for example the coffee grounds that are tamped against a filter plate by a pressing piston that slides inside the chamber, along its longitudinal axis, which, in a preferred mode of the invention, is a vertical axis. The hot brewing water arrives at the bottom of the chamber, passes through the filter and grounds, and the brew obtained is evacuated through the pressing piston. The coffee “puck” which results therefrom is pushed outside the brewing chamber by a shank, or rod, of an ejection mechanism that passes through the boiler body, which must thus have a sufficient thickness to limit the losses of heat towards the outside.

This ascending circulation of the brew through the boiler body heated in a homogeneous way in all its volume at a temperature close to 100° C., for an assigned temperature of the heating element fixed at around 105° C. at 120° C., then allows a good extraction of the coffee essences at around 92° C. to 96° C. and, after having traversed the pressing piston, to obtain coffee in the cup at a temperature of around 72° C. to 75° C., ideal for coffee enjoyment.

In addition, to produce steam, the assigned temperature of the heating element is around 130° C. to 140° C. After passage of the steam in its conduit, through the boiler body, because, on the one hand, of the arrangement of the water conduit at a distance and, on the other hand of the continuous ascending circulation of the brewing water, impelled by the pumping means of pumping, which thus quickly evacuates the possible calories accumulated by the boiler body at the time of the preceding phase, the appliance can then make coffee immediately after having produced steam.

The invention also relates to a process for manufacturing an improved boiler for a brewed beverage distributor, process which comprises the following steps:
to assemble the water conduit, the steam conduit, the heating element and the brewing chamber on a template;
to form a subassembly by securing together the water conduit, the steam conduit, the heating element and the chamber by fastening means;
to place said subassembly inside a mold by orienting it along the terminations of the heating element and/or the end pipes of the steam or water conduits that are parallel to a median positioning plane of the body of said boiler;
to close the mold along a mating plane perpendicular to said median positioning plane;
to carry out an overmolding of said subassembly by delivering molten metal under pressure into said mold.

The invention and its advantages will be better understood from a study of a preferred embodiment taken on a nonlimiting basis and illustrated in the annexed figures in which:

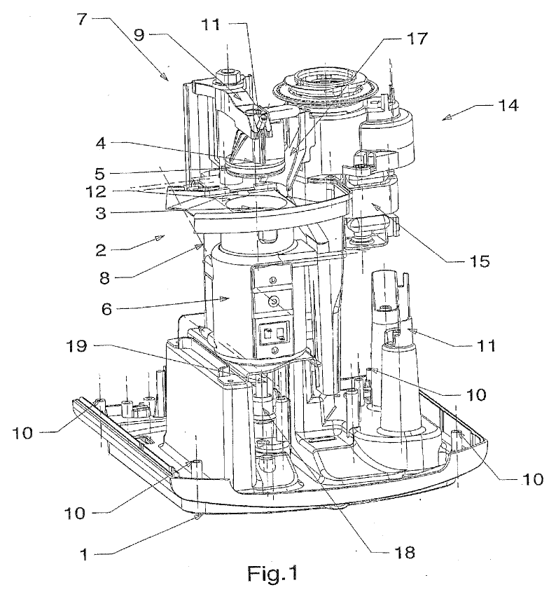

FIG. 1 is a perspective view of a distributor according to the invention, certain of its components being omitted for greater clarity;

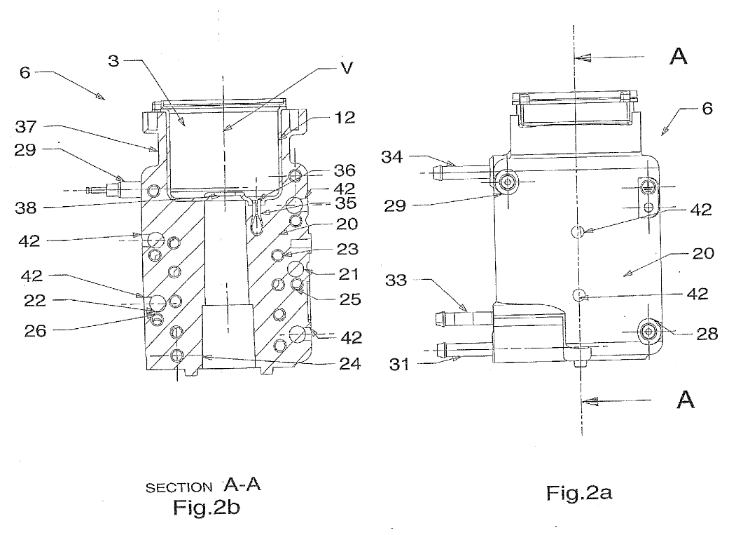

FIG. 2a is a side view of a boiler of the distributor of FIG. 1;

FIG. 2b is an axial cross-sectional view along plane A-A of FIG. 2a;

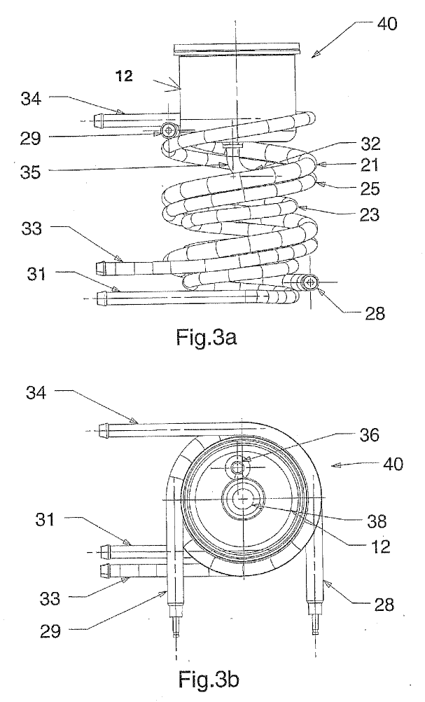

FIG. 3a is a side view of a subassembly of the boiler of FIG. 2a;

FIG. 3b is a top view of the subassembly of FIG. 3a.

The automatic distributor shown in FIG. 1 is an automatic coffee machine adapted to make espresso coffee and it comprises a case (partly removed in the figure) whose base 1 is visible and forms a support for the components of the appliance which will be described thereafter. The upper part of the case comes to be fixed on base 1 by screws installed in openings 10 provided for this purpose on the circumference of base 1. There will be observed in FIG. 1 a brewing group 2 composed of a brewing chamber 3 having a tank 12 adapted to receive a certain quantity of ground coffee above a lower wall forming a filter plate for the grounds. In this example, the brewing chamber 3 is mounted in a fixed manner above a boiler 6, having a vertical axis V, of which it constitutes the prolongation. Boiler 6 has a heating element and ensures the supply of hot water to the brewing chamber 3, as will be explained thereafter.

In fact, the boiler could be dissociated from the brewing chamber or could be arranged horizontally.

The appliance in addition comprises a ground coffee distributor that is, in the example represented on FIG. 1, a grinder 14 of coffee beans. The grinder or coffee mill generally comprises a reservoir for coffee beans in the upper part and, in the lower part, a shaft driven in rotation by an electric motor 15 to actuate a burr rotating opposite a fixed burr, coffee beans being introduced between these burrs to leave in a ground state through a distribution opening through which it passes into a chute 17. Chute 17 has the general shape of a ski jump inclined to the vertical and it is oriented in the direction of the brewing chamber 3 which it supplies with grounds coming from grinder 14.

Brewing chamber 3 also receives a pressing piston 4 that slides along the same vertical axis to compact the coffee grounds inside brewing chamber 3. Pressing piston 4 has an O ring 5 allowing the sealing with the brewing chamber 3 during the making of the coffee. The appliance also comprises means 7 for actuation of pressing piston 4, which are constituted, in the example represented, by a hydraulic actuating cylinder 8 having an internal piston that is connected to pressing piston 4 via a rigid bar 9. Hydraulic actuating cylinder 8 receives a liquid under pressure coming from the hydraulic system of the appliance, liquid which moves the piston of the jack to the bottom at the same time as the pressing piston 4, which passes then from a home position (in the upper part of the appliance) to a work position, while descending vertically in the direction of the brewing chamber 3 to compress the grounds. Hot water is then sent through the grounds and the brewed beverage is then evacuated through the pressing piston 4 in which is provided a conduit prolonged towards the outside by a discharge channel 11 that directs the beverage obtained towards a cup outside the machine. The hydraulic actuating cylinder described here is a single acting jack, the return to the home position of the piston of the jack being achieved by a spring located in the lower part of the hydraulic actuating cylinder. Such a jack and actuation of the pressing piston are described more fully in document WO 99/12457.

In addition, the machine described here is equipped with a duct (not represented) for delivery of hot water or steam that can be used with an accessory for cappuccino assembled at its end. Hot water or steam exiting by this duct is produced inside boiler 6, in an independent conduit, while using, in an advantageous way, the same electric heating element as that which is used to produce the water hot for brewing, but controlled according to a different assigned temperature, such as will be explained below.

According to the invention and as better seen in FIG. 2b, boiler 6 is present in the form of a heating block whose body 20 integrates a triple helix structure made up of three tubular parts coiled in a helix around and along the longitudinal axis V of boiler 6, in particular: an electric heating element 21, a water conduit 23, as well as a steam conduit 25. Body 20 is made of an aluminum alloy by injection in a mold, such as will be explained hereafter. Body 20 has a diameter comprised between 60 and 70 mm and has a height (brewing chamber included) of approximately 90 to 100 mm. A central bore 24 crosses to the bottom of brewing chamber 3 to allow passage of shank 19 of ejection mechanism 18. In this example, brewing chamber 3 forms a common body with that of boiler 6. Body 37 of the brewing chamber is obtained by overmolding of tank 12 with the triple helix structure of the boiler.

Heating element 21 is a sheathed electric resistance having a power comprised between 1200 and 1500 W. Its connections to the electric circuit of the appliance are made with the help of pins, which leave at the end of each one of its terminations 28,29 (FIG. 2a). Terminations 28,29 are straight and projecting with respect to body 20 of the boiler and one is in the lower part and the other in the upper part of body 20 of boiler 6. Heating element 21 is arranged towards the periphery of body 20, its length comprised between 400 and 600 mm, the parameters of its helix were estimated in order to ensure a good temperature distribution inside body 20. As an example, there was chosen an external diameter of 56 mm and a pitch of 26 mm for the helix of heating element 21.

Water conduit 23 is a stainless steel tube of sufficient length to heat to a good temperature water passing through it, without taking account of its initial conditions of operation. As an example, its length can be comprised between 500 and 700 mm. This tube is disposed at a distance from heating element 21, its helix presenting, as an example, an external diameter of 40 mm and a pitch of 12 mm. Water conduit 23 includes an external pipe 31 for water entry which is straight and is located in the lower part of body 20, projecting with respect to the latter. Its water exit end presents a straight part 32 (FIG. 3a) then an elbow 35, which emerges through an opening 36 at the bottom of the brewing chamber 3.

Steam conduit 25 is a stainless steel tube of sufficient length so that it can transform water passing through it into steam. For this purpose, steam conduit 25, having a length comprised between 450 and 650 mm, must be located closer to heating element 21, and must have characteristics (pitch, diameter) of its helix very close to or equal to those of the latter so that it can recover to the maximum the heat provided by heating element 21. In the example represented which uses an overmolding technique to construct the assembly forming boiler 6, external wall 26 of steam conduit 25 and external wall 22 of the heating element are located at a distance of approximately 2 mm in order to avoid the formation of insulating bubbles of air between the two at the interior of body 20 during the injection of material into the mold. Steam conduit 25 comprises, in the lower part of body 20, an end pipe 33 for the entry of water for the production of steam and, in the upper part of body 20, an end pipe 34 for the exit of steam, the two pipes being straight and projecting with respect to body 20 of boiler 6.

FIGS. 3a and 3b illustrate a subassembly 40 comprising tank 12, and the triple spiral structure made up of heating element 21, water conduit 23 and steam conduit 25 fixed to one another before overmolding. Each spiral or helix is composed of, preferably, at least two closed loops each one at a height different from that at the start. Before fixing them together, these components are positioned relative to one another on an assembly template not represented in the figures.

Thus, it is observed in this arrangement that the two end pipes 31, 33 for entry of water for brewing and water for steam are parallel and are located in the lower part of subassembly 40, whereas end pipe 34 for exit of steam is located in the upper part of subassembly 40, while being parallel to the entry pipes. The hot water outlet pipe presents a straight end pipe 32 that is prolonged upwardly by an elbow 35 that emerges through an opening 36 in tank 12 of the brewing chamber. Elbow 35 is fixed at the bottom of the tank, by welding, brazing, bonding, etc. As can be seen in FIG. 3b, opening 36 is disposed in an eccentric manner in the bottom of tank 12, which comprises in the center an opening 38 for passage of shank 19 of the mechanism for ejection of the filter plate supporting the coffee grounds. Such an ejection mechanism is described better in document WO 99/12455.

Heating element 21 is disposed on the template so that its terminations 28, 29 are perpendicular to the end pipes 31, 32,33,34 of the water and steam conduits, termination 28 being arranged in the lower part of subassembly 40.

When all the components of subassembly 40 have been positioned on the assembly template, they are fixed together by attachment means, for example by welding or bonding (for example by using a polyurethane adhesive) of metal plates along the tubes.

After assembly and fixing together, the template is removed and subassembly 40 is positioned inside a mold. Subassembly 40 is introduced inside a mold by positioning it with respect to heating element 21, in particular by introducing terminations 28, 29 of the latter in openings provided to this end in the wall of the mold and by using centering pins that are supported on the turns of heating element 21. Openings 42 (FIG. 2b) resulting after overmolding are evidence of the presence of these centering pins.

Once subassembly 40 is set up, the mold is closed along a mating plane which follows, at the center, a first median plane of the subassembly 40 that is perpendicular to a second median plane parallel to terminations 28,29 of heating element 21. The path of the mating plane passes, in the lower part, through planes containing the axis of end pipes 31, 33 and, in the upper part, through another plane containing the axis of pipe 34. The injection of an aluminum alloy into the interior of the mold then takes place. The injected alloy must have good properties of adherence to stainless steel and flowability in order to fill the space of the mold well, without trapping insulating bubbles of air, especially in contact with the structure of the subassembly. Such an alloy is for example AS9U3 or ADC10 which is a non-food aluminum alloy, but of a very good flowability.

The boiler thus obtained is that shown in FIGS. 2a and 2b and it is mounted in its support inside the machine, the end pipes of the water and steam conduits are connected to the hydraulic circuit of the machine and the heating element is connected to the electric circuit.

In operation, when it is desired to make coffee, heating element 21 is controlled, with the aid of a thermostat fixed on boiler 6, to an assigned temperature of 105° C. to 120° C. The cold water propelled by a pump at 15 bars mounted upstream of the boiler arrives, via a multiway valve, at inlet end pipe 31 and it is heated while passing along, in the ascending direction, water conduit 23 over its entire length to the outlet via opening 36 inside brewing chamber 3. Water conduit 23 is itself heated by the aluminum mass of body 20, its length and its diameter being estimated so that the water which traverses it arrives at the outlet at a temperature close to 100° C. to allow a good brewing of the coffee when it passes through the coffee grounds inside brewing chamber 3. The brew obtained flows to the exterior the machine, into a cup, through a discharge channel provided in the pressing piston, such as described better in the document WO 99/12456. In addition, when it is desired to produce hot water to prepare tea, for example, heating element 21 is controlled to a temperature of approximately 100° C. to 115° C. and hot water is delivered into steam conduit 25 and is heated by traversing it, over all its length before exiting via an outlet duct provided for this purpose. The water temperature at the outlet is around 88° C. to 98° C. The length and the diameter of this conduit and its arrangement close to heating element 21 have been selected so that one obtains, in an economical manner, very good thermal performances.

For production of steam, heating element 21 is controlled to a higher temperature, comprised between 130° C. and 140° C. The flow rate of water supplied by the pump downstream of steam conduit 25 is lower than previously, and it is controlled automatically by the electronic circuit board of the appliance. The steam obtained is sent to the exterior by an outlet duct and can be used to heat milk, to produce cappuccino, etc.

Other alternatives and embodiments can be considered without leaving the framework of these claims.

Thus, one could consider a boiler whose body encloses in a sealed manner a triple spiral structure according to the invention and where the interior space of the body is filled with a heat-retaining fluid, for example an oil.

1. Brewed beverage distributor having a case containing means for pumping water from a tank to send it through a boiler (6) into a brewing chamber (3) containing a product to be brewed, then to evacuate it in brewed form out of the chamber, said boiler (6) comprising a cylindrical body (20) integrating an electric heating element (21) and a water conduit (23), the heating element (21) and said water conduit (23) forming two helices of different diameters coiled around the longitudinal axis (V) of the boiler body, substantially over its entire height, characterized in that said boiler body (20) integrates a steam conduit (25) forming a helix arranged along the longitudinal axis (V) of the boiler (6), substantially over its entire height.

2. Beverage distributor according to claim 1, characterized in that the winding diameter of the steam conduit (25) and the pitch of its helix are appreciably equal to those of the helix of the heating element (21).

3. Beverage distributor according to claim 2, characterized in that the external wall (26) of the steam conduit (25) is adjacent to that (22) of the electric heating element (21).

4. Beverage distributor according to claim 3, characterized in that said water conduit (23) and steam conduit (25) are metal tubes that are overmolded together with the heating element (21), to form the body (20) of the boiler (6).

5. Beverage distributor according to claim 4, characterized in that said water conduit (23) and steam conduit (25) are composed of end pipes (31, 32,33,34) that are straight and in that said heating element (21) is composed of terminations (28,29) that are straight, the end pipes (31, 32,33,34) and terminations (28,29) being oriented along the tangent to the external diameter of their respective helix.

6. Beverage distributor according to claim 5, characterized in that at least a part of said end pipes (31, 32,33,34) of said conduits and/or at least one of said terminations (28,29) are parallel to a first median plane of the body (20) of the boiler (6) which is perpendicular to a second median plane of the body (20) of the boiler (6) which is, itself, parallel to the other end pipes (31, 32,33,34) and/or to the other termination or terminations (28,29).

7. Beverage distributor according to claim 6, characterized in that one of the end pipes (32) of said water conduit is prolonged by an elbow (35) which emerges at the bottom of a brewing chamber (3) oriented along the longitudinal axis of said boiler (6) and with which it forms a single part.

8. Beverage distributor according to claim 7, characterized in that said brewing chamber (3) is overmolded with said body (20) of the boiler (6).

9. Beverage distributor according to claim 8, characterized in that the ratio between the external diameter of the body (37) of the chamber of brewing (3) and that of the body (20) of said boiler (6) is comprised between 0.6 and 0.8.

10. Beverage distributor according to claim 9, characterized in that said brewing chamber (3) comprises a filter plate and receives a pressing piston (4) displaceable along the longitudinal axis of the boiler while being actuated by a drive means (7) and presenting a conduit for passage of the brewed product towards an outlet opening under the effect of said pumping means when the piston (4) closes the brewing chamber (3), said filter plate being mounted movably in said brewing chamber by means of an ejection mechanism (18) comprising a shank (19) slidably mounted in a bore (24) formed in the body (20) of said boiler (6) along its longitudinal axis.

11. Process for manufacture of an improved boiler for a brewed beverage distributor according to claim 1, characterized in that it comprises the following steps:
assembling the water conduit, the steam conduit, the heating element and the brewing chamber on a template;
forming a subassembly by securing together the water conduit, the steam conduit, the heating element and the chamber by fastening means;
placing said subassembly inside a mold by orienting said subassembly along the terminations of the heating element and/or the end pipes of the steam or water conduits that are parallel to a median positioning plane of the body of said boiler;
closing the mold along a mating plane perpendicular to said median positioning plane; and
carrying out an overmolding of said subassembly by delivering molten metal under pressure into said mold.

12. Beverage distributor according to claim 1, characterized in that the external wall (26) of the steam conduit (25) is adjacent to that (22) of the electric heating element (21).

13. Beverage distributor according to claim 12, characterized in that said water conduit (23) and steam conduit (25) are metal tubes that are overmolded together with the heating element (21), to form the body (20) of the boiler (6).

14. Beverage distributor according to claim 1, characterized in that said water conduit (23) and steam conduit (25) are composed of end pipes (31, 32,33,34) that are straight and in that said heating element (21) is composed of terminations (28,29) that are straight, the end pipes (31, 32,33,34) and terminations (28,29) being oriented along the tangent to the external diameter of their respective helix.

15. Beverage distributor according to claim 5, characterized in that one of the end pipes (32) of said water conduit is prolonged by an elbow (35) which emerges at the bottom of a brewing chamber (3) oriented along the longitudinal axis of said boiler (6) and with which it forms a single part.

16. Beverage distributor according to claim 4, characterized in that said brewing chamber (3) is overmolded with said body (20) of the boiler (6).

17. Beverage distributor according to claim 1, characterized in that said brewing chamber (3) comprises a filter plate and receives a pressing piston (4) displaceable along the longitudinal axis of the boiler while being actuated by a drive means (7) and presenting a conduit for passage of the brewed product towards an outlet opening under the effect of said pumping means when the piston (4) closes the brewing chamber (3), said filter plate being mounted movably in said brewing chamber by means of an ejection mechanism (18) comprising a shank (19) slidably mounted in a bore (24) formed in the body (20) of said boiler (6) along its longitudinal axis.
